(19) United States
(12) Patent Application Publication
(10) Pub. No.: US 2026/0228326 A1
(43) Pub. Date: Aug. 6, 2026

(54) ELECTRONIC DEVICE FOR PERFORMING ARTIFICIAL NEURAL NETWORK-BASED INFERENCE IN TRUSTED EXECUTION ENVIRONMENT AND OPERATING METHOD THEREOF

(71) Applicants: Samsung Electronics Co., Ltd., Suwon-si (KR); UIF (University Industry Foundation), Yonsei University, Seoul (KR)

(72) Inventors: Buyoung Yun, Suwon-si (KR); Dokyung Song, Seoul (KR); Jungtae Kim, Suwon-si (KR); Jongkwon Park, Suwon-si (KR); Junho Choi, Suwon-si (KR); Myungsuk Moon, Seoul (KR)

(21) Appl. No.: 19/436,252

(22) Filed: Dec. 30, 2025

(30) Foreign Application Priority Data
Feb. 4, 2025 (KR) 10-2025-0013934
May 27, 2025 (KR) 10-2025-0069179

(51) Int. Cl. G06F 21/52; G06N 3/042; G06N 3/063

(52) U.S. Cl. CPC G06F 21/52; G06N 3/042; G06N 3/063; G06F 2221/033

(57) ABSTRACT

An electronic device includes a central processing unit (CPU), a neural processing unit (NPU), and memory including at least one NPU enclave having a trusted execution environment (TEE) isolated from a rich execution environment (REE) in which system software of the CPU is executed, wherein the CPU is configured to, from computational graph information of an artificial neural network stored in the at least one NPU enclave, identify a first operator supported by the NPU and a second operator not supported by the NPU, and adjust an execution order of operators of a computational graph to reduce the number of transitions between the TEE configured to perform the first operator and the REE configured to perform the second operator.

### CROSS-REFERENCE TO RELATED APPLICATIONS

This application is based on and claims priority under 35 U.S.C. § 119 to Korean Patent Application Nos. 10-2025-0013934, filed on Feb. 4, 2025 and 10-2025-0069179, filed on May 27, 2025, in the Korean Intellectual Property Office, the disclosures of each of which are incorporated by reference herein in their entireties.

### BACKGROUND

Due to the recent rapid development and population of generative artificial intelligence (GenAI) in a mobile environment, vendors in various industries may be facing new challenges in the protection of their proprietary AI models. GenAI technology may be capable of generating various forms of advanced data such as text, images, and applications, thereby leading technological innovation together with expanding business opportunities. However, the GenAI models may be exposed to the risk of replication and abuse.

A trusted execution environment (TEE) may protect sensitive data and operations in the on-device. The TEE may be a separate security area within a processor, which protects data and code from external codes, and provide a secure operation environment through encryption and integrity verification.

### SUMMARY

The present disclosure relates to data security, and more particularly, to a device and method for reducing latency caused by a neural processing unit (NPU) interrupt during an inference operation of an artificial neural network while providing a safe execution environment to an NPU.

The present disclosure provides a method of minimizing the number of neural processing unit (NPU) interrupts (or context switching occurred for an NPU interrupt to be processed through a rich execution environment (REE) kernel driver (e.g., a trusted execution environment (TEE)-to-REE transition) by adjusting the execution order of operators within a deep neural network (DNN), and accordingly, effectively reducing inference latency in the TEE.

According to an aspect of the present disclosure, there is provided an electronic device including a central processing unit (CPU), an NPU, and memory including at least one NPU enclave having a TEE isolated from an REE in which system software of the CPU is executed, wherein the CPU is configured to, from computational graph information of an artificial neural network stored in the at least one NPU enclave, identify a first operator supported by the NPU and a second operator not supported by the NPU, and adjust an execution order of operators of a computational graph to reduce the number of transitions between the TEE configured to perform the first operator and the REE configured to perform the second operator.

According to another aspect of the present disclosure, there is provided a method of performing an artificial neural network-based inference of a CPU included in an electronic device, wherein the electronic device further includes an NPU and memory including at least one NPU enclave having a TEE isolated from an REE in which system software of the CPU is executed, the method including, from computational graph information of an artificial neural network stored in the at least one NPU enclave, identify a first operator supported by the NPU and a second operator not supported by the NPU, and adjusting an execution order of operators of a computational graph to reduce the number of transitions between the TEE configured to perform the first operator and the REE configured to perform the second operator.

According to another aspect of the present disclosure, there is provided an electronic device including a system on chip (SoC) including a CPU and an NPU, and memory including at least one NPU enclave having a TEE isolated from an REE in which system software of the CPU is executed, wherein the CPU is configured to, from computational graph information of an artificial neural network stored in the at least one NPU enclave, identify a first operator supported by the NPU and a second operator not supported by the NPU, and adjust an execution order of operators of a computational graph to reduce the number of transitions between the TEE configured to perform the first operator and the REE configured to perform the second operator.

### BRIEF DESCRIPTION OF THE DRAWINGS

Implementations will be more clearly understood from the following detailed description taken in conjunction with the accompanying drawings in which:

FIG. 1 is a block diagram illustrating an electronic device according to an implementation;

FIG. 2 is a diagram illustrating an example of an execution environment of an electronic device according to an implementation;

FIG. 3 is a diagram for explaining an example of an operation of an execution environment of an electronic device according to a comparative example;

FIG. 4 is a diagram for explaining an example of an operation of an execution environment of an electronic device according to an implementation;

FIG. 5 is a flowchart illustrating a method of performing an artificial neural network-based inference according to an implementation;

FIG. 6 is a flowchart for explaining in more detail operation S120 of a method of performing an artificial neural network-based inference according to an implementation;

FIG. 7 is a flowchart of a greedy-based division algorithm that divides a computational graph into a plurality of subgraphs, according to an implementation;

FIGS. 8A to 8F are examples for explaining a greedy-based division algorithm according to an implementation;

FIGS. 9, 10, and 11 are diagrams for explaining that the number of transitions from a trusted execution environment (TEE) to a rich execution environment (REE) (TEE-to-REE transition) is reduced, according to implementations;

FIG. 12 is a diagram illustrating an example of a system according to an implementation; and

FIG. 13 is a diagram illustrating an example of an electronic device according to an implementation.

### DETAILED DESCRIPTION

First, “each of modules” described herein may correspond to hardware, software, or a combination of hardware and software included in a computing system. The hardware may include at least one of a programmable component such as a central processing unit (CPU), a digital signal processor (DSP), and a graphics processing unit (GPU), a reconfigurable component such as a field programmable gate array (FPGA), or a component that provides fixed functions such as an integrated property (IP) block. The software may include at least one of a series of instructions executable by a programmable component and code convertible into a series of instructions by a compiler, and may be stored in a non-transitory storage medium.

As discussed above, a trusted execution environment (TEE) may protect sensitive data and operations in the on-device. The TEE may be a separate security area within a processor, which protects data and code from external codes, and provide a secure operation environment through encryption and integrity verification.

In particular, when a mobile device performs a DNN inference operation in the TEE, an additional path may occur in which an NPU interrupt is transferred to the TEE through a rich execution environment (REE) during an operation process using an NPU and a central processing unit (CPU). As a result, an interrupt transfer path may increase, which may cause a problem that the latency of a DNN inference operation increases. Aspects of the present disclosure may address the above-discussed issues in the related art.

Hereinafter, an implementation will be described in detail with reference to the accompanying drawings.

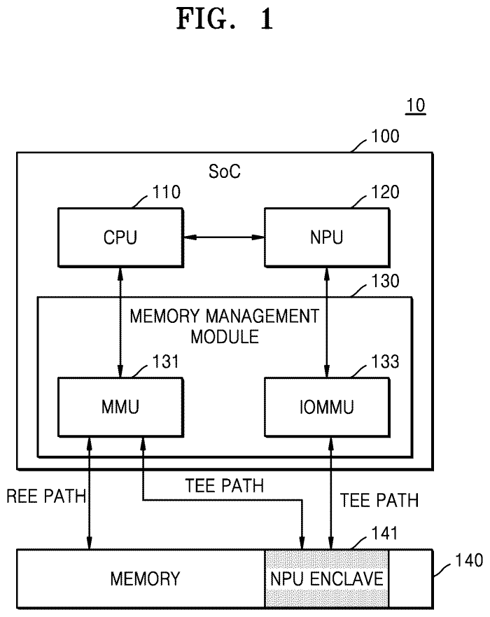

FIG. 1 is a block diagram illustrating an electronic device according to an implementation.

An electronic device 10 may be included in various devices such as a drone, an advanced driver assistance system (ADAS), a smart TV, a smartphone, a medical device, a mobile device, an image display device, a measurement device, and an Internet of Things (IoT) device. In some implementations, the electronic device 10 may be implemented as a component of various electronic devices such as a mobile device, a smartphone, a vehicle, furniture, manufacturing facilities, a door, and various measurement devices. In some implementations, the electronic device 10 may be included in various types of electronic devices to which the technical idea of the present disclosure is applicable.

Referring to FIG. 1, the electronic device 10 may include a system on chip (SoC) 100 and memory 140. The SoC 100 and the memory 140 may exchange data with each other.

The SoC 100 may include a CPU 110, a neural processing unit (NPU) 120, and a memory management module 130. In some implementations, the SoC 100 may further include other general-purpose components such as a GPU and an internal memory of the SoC in addition to the components described above. In some implementations, unlike shown in FIG. 1, the NPU 120 and an input/output memory management unit (IOMMU) 133 may be implemented as separate chips or modules outside the Soc 100 as separate accelerators.

In the electronic device 10, execution environments may be divided into a rich execution environment (REE) and a trusted execution environment (TEE). The REE may mean an environment in which system software (e.g., an operating system or application executed in the REE) of the CPU 110 is executed. The TEE refers to a secure execution environment isolated from the REE, and may be implemented by software and/or hardware.

The TEE is physically or logically separated from the REE so that an operating system or an application executed in the REE may not directly access data or codes inside the TEE, thereby protecting important information from malware or unauthorized software.

For example, the TEE may be implemented by separately including an execution isolation space implemented at a processor architecture level inside the CPU 110 by using encrypted internal memory and a security processor. The execution isolation space inside the CPU 110 may be directly managed by the CPU 110 in hardware and be strictly separated from the REE in memory access, code execution, data protection, etc. to ensure security.

In some implementations, referring to FIG. 1, the memory 140 may include an NPU enclave 141 having the TEE.

Here, the NPU enclave 141 may mean an area of the memory 140 that may not be accessed by software not authorized to access, such as system software of the CPU 110 of the REE. For example, the NPU enclave 141 has an execution environment independent of the REE of the CPU 110, thereby providing a safe execution environment, even when the REE is not reliable. In some implementations, the NPU enclave 141 may be referred to as private memory.

The NPU enclave 141 is expressed as one area in FIG. 1, but is not limited thereto, and the memory 140 may include at least one or more NPU enclaves 141.

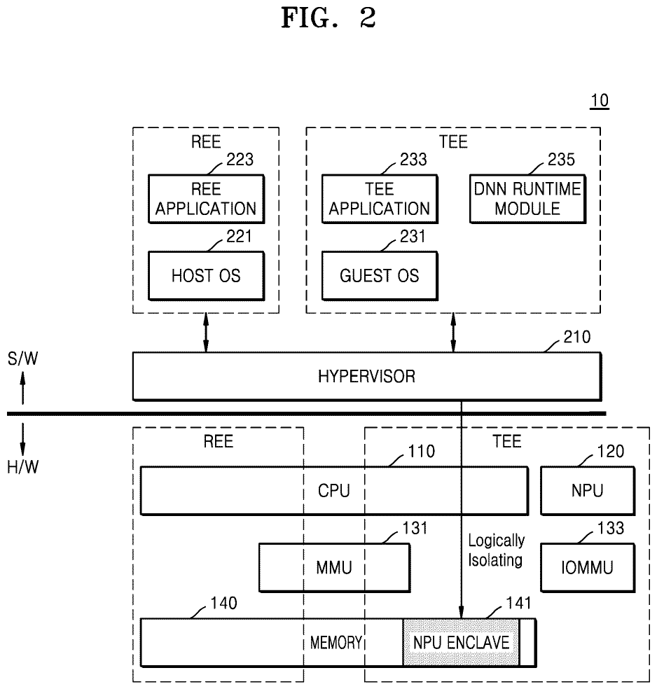

In some implementations, the NPU enclave 141 may be implemented as a logically isolated area from a virtualization-based TEE by a hypervisor 210 (FIG. 2). This will be described in detail with reference to FIG. 2.

The memory management module 130 may control programs executed by the CPU 110 or the NPU 120 to be accessed by the memory 140. For example, when a program attempts to access a specific area included in the memory 140, the memory management module 130 may verify the program and block the access.

Referring to FIG. 1, the memory management module 130 may include a memory management unit (MMU) 131 and an IOMMU 133. An application of the CPU 110 executed in the TEE may access the NPU enclave 141 through the MMU 131 (TEE PATH), and similarly, the NPU 120 executed in the TEE may directly access the NPU enclave 141 through the IOMMU 133 (TEE PATH). On the other hand, system software of the CPU 110 having the REE may access the area of the memory 140 except for the NPU enclave 141 through the MMU 131 (REE PATH).

Here, the MMU 131 may convert a virtual address of the CPU 110 into a physical address, and control and protect the memory access of the CPU 110. In some implementations, the IOMMU 133 may convert a virtual address of an input/output device (e.g., the NPU 120) using a direct memory access (DMA) into a physical address and control and protect the memory access of the input/output device (e.g., the NPU 120) using the DMA.

In some implementations, the memory management module 130 may encrypt or decrypt data to enhance security. For example, because there is a possibility of an attack by malicious software on the outside of SoC 100, when data inside the SoC 100 is transmitted to the outside, the memory management module 130 may encrypt the data. In some implementations, on the contrary, when receiving encrypted data from the outside, the memory management module 130 may decrypt the encrypted data received from the outside.

The memory 140 may be memory outside the SoC 100. For example, the memory 140 may be dynamic random access memory (DRAM), but is not limited thereto. In some implementations, the CPU 110 and the NPU 120 may share and use the memory 140. For example, in the TEE, the CPU 110 and the NPU 120 may share the same NPU enclave 141.

Because the outside of the SoC 100 may be exposed to a malicious attack, the memory 140 may be vulnerable in security. For example, a malicious operating system may access a page table of a user application stored in the memory 140, and a data transmission passage between the memory 140 and the SoC 100 may be tapped. Therefore, the NPU 120 that accesses or processes data stored in the memory 140 may not be provided with a secure execution environment. Accordingly, a reliable protection area needs to exist in the memory 140, and the memory 140 according to implementations of present disclosure includes the NPU enclave 141 described above, thereby providing the TEE capable of safely processing sensitive data to the NPU 120.

The CPU 110 may be configured to control operations of a plurality of components included in the electronic device 10.

For example, the CPU 110 may receive data from the memory 140. For example, the CPU 110 may receive data from the memory 140 and store the data in internal memory of the SoC 100. The internal memory of the SoC 100 may be scratchpad memory included in the NPU 120, or may be memory included in the SoC 100 separately from the NPU 120. When the internal memory of the SoC 100 is scratch pad memory, the internal memory may be static random access memory (SRAM), but is not limited thereto.

Referring to FIG. 1, when the CPU 110 operates in the REE, the CPU 110 may receive data from a general area of the memory 140 rather than the NPU enclave 141 through the MMU 131 (REE PATH). When the CPU 110 operates in the TEE, the CPU 110 may receive data from the NPU enclave 141 of the memory 140 through the MMU 131 (TEE PATH).

The NPU 120 may perform an NPU operation (e.g., a multiplication operation) on the data received from the memory 140, and transmit a result of the NPU operation to the memory 140. For example, in response to a command of the CPU 110, the NPU 120 may perform an NPU operation (e.g., a multiplication operation) on the data received from the memory 140. In some implementations, in response to the command of the CPU 110, the NPU 120 may transmit a result of the NPU operation to the memory 140. Referring to FIG. 1, the NPU 120 may transmit a result of the NPU operation to the NPU enclave 141 of the memory 140.

Referring to FIG. 1, when the NPU 120 operates in the TEE, the NPU 120 may receive data from the NPU enclave 141 of the memory 140 through the IOMMU 133 (TEE PATH). For example, the NPU 120 according to implementations of present disclosure may directly access the NPU enclave 141 through the IOMMU 133 (TEE PATH).

In the implementation, the CPU 110 and/or the NPU 120 may perform an inference operation in the TEE. For example, in response to an inference request from an application of the REE of the CPU 110, the CPU 110 and/or the NPU 120 may perform the inference operation in the TEE.

Hereinafter, it is assumed that the NPU enclave 141 receives artificial neural network data from a remote model provider (e.g., a server) through a secure and authenticated channel and stores the artificial neural network data in advance.

For example, the artificial neural network data may refer to overall data (e.g., model parameters, weights, structures (or computational graph information), input pre-processing data, etc.) required for inference of an artificial neural network model. In some implementations, for example, the artificial neural network data may be sealed or encrypted and stored in unreliable local storage (e.g., flash memory, SSD, eMMC, etc.) before the NPU enclave 141 is terminated. Thereafter, when the same NPU enclave 141 is rebooted, the sealed artificial neural network data from the corresponding local storage may be unsealed or decrypted, and then loaded back into the NPU enclave 141.

The CPU 110 may generate result data including a confidence score and a predicted label by performing the inference operation based on the artificial neural network data stored in the NPU enclave 141 in the TEE. In some implementations, the CPU 110 in the TEE may return result data including only the predicted label excluding the confidence score to the application of the REE of the CPU 110 as a return value. Accordingly, the CPU 110 may return only the predicted label excluding the confidence score from among the generated result to the application of the REE of the CPU 110, thereby protecting sensitive information.

In some implementations, in the TEE, the CPU 110 may perform an inference operation in cooperation with the NPU 120.

For example, in the TEE, the CPU 110 may identify a first operator supported by the NPU 120 and a second operator not supported by the NPU 120 from the computational graph information of the artificial neural network stored in NPU enclave 141.

Here, the computational graph information, which is data representing an operation structure of the artificial neural network model, may include operator nodes and edges defining a data flow between the operator nodes. Here, the operator node may include addition, multiplication, convolution, activation functions (ReLU, Sigmoid, etc.), batch normalization, or other data conversion functions, and the edge may represent a relationship in which a single operation result is transferred to an input of the next operator.

In some implementations, here, the first operator, which is an operator supported by the NPU 120 in a hardware manner, may mean an operator that may be performed directly by an operation unit implemented inside the NPU 120. For example, the first operator may be a fixed neural network operator that performs fundamentally or repeatedly, such as convolution, matrix multiplication, and an ReLU function. The second operator, which is not directly performed by the NPU 120, may be an operator not supported in a hardware manner, or includes a custom operation, an if-statement, a loop, or a complex control flow. The second operator may be performed by a general-purpose processor such as the CPU 110 in a software manner. In some implementations, the second operator performed by the CPU 110 may be referred to as a CPU-fallback operator.

For example, an operator such as conv, matrix multiplication, activation functions (ReLU, Sigmoid, etc.), pooling, etc. may correspond to the first operator because an operation may be directly performed by the NPU 120, and an operation such as an if-statement, a loop, a Top-K operation, or a custom operation may correspond to the second operator because the operation may not be directly supported by the NPU 120.

For example, according to whether the NPU 120 may directly process the corresponding operation for each operator on the computational graph, the operator may be classified as the first operator or the second operator.

In the implementation, the identification information of each of the operators may be included in the computational graph information of the artificial neural network in a metadata format. For example, the identification information may be tag data in which an operator corresponding to the first operator supported by the NPU 120 is indicated as 0 or False, and an operator corresponding to the second operator not supported by the NPU 120 is indicated as 1 or True. Accordingly, the CPU 110 may easily identify the first operator supported by the NPU 120 and the second operator not supported by the NPU 120 based on the identification information of each operator.

Thereafter, the CPU 110 may schedule an execution order so that the first operator is performed by the NPU 120 and the second operator is performed by the CPU 110, based on the identified operators.

Here, the first operator and the second operator may be performed alternately, and accordingly, a series of context switching (e.g., a TEE-to-REE transition from the TEE to the REE or a REE-to-TEE transition from the REE to the TEE) may occur.

For example, the NPU 120 may perform an operation on the first operator, and generate an NPU interrupt to the CPU 110 such that when the next operator is the second operator not supported by the NPU 120, the CPU 110 performs an operation on the second operator. In this regard, because the NPU interrupt needs to be processed through a kernel driver of the CPU 110 of the REE, the TEE-to-REE transition from the TEE to the REE may occur. Subsequently, in order for the kernel driver of the CPU 110 of the REE to transfer the NPU interrupt to the CPU 110 of the TEE in the form of a virtual interrupt, the REE-to-TEE transition from the REE to the TEE may occur. The CPU 110 of the TEE may receive the virtual interrupt and perform an operation on the second operator as a result of the processing. Thereafter, the virtual interrupt needs to be acknowledged, and in order to transmit an acknowledgement signal to the CPU 110 of the REE, the TEE-to-REE transition from the TEE to the REE may occur.

For example, in order to process a single NPU interrupt, transitions between the TEE and the REE may occur at least two to three times, which may cause an inference latency in the TEE.

According to implementations of present disclosure, the electronic device 10 may reduce the number of transitions from the TEE to the REE by adjusting the execution order of operators of the artificial neural network. Accordingly, according to implementations of present disclosure, the inference latency in the TEE may be effectively reduced.

Operations of the electronic device 10 according to implementations of present disclosure will be described in detail with reference to FIGS. 2 to 11.

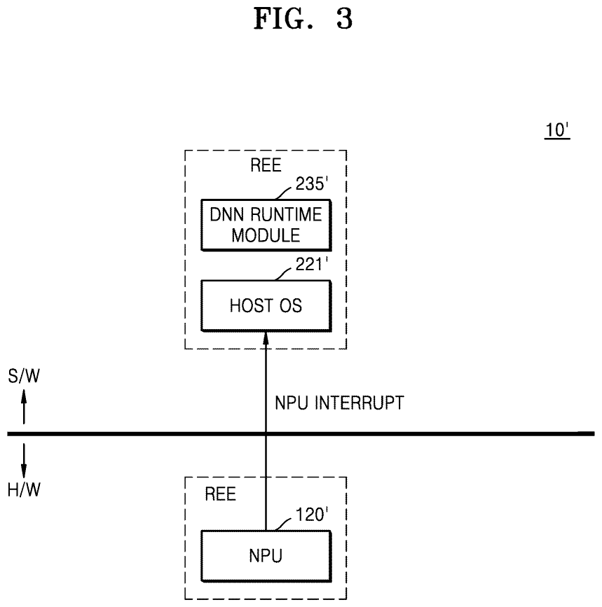

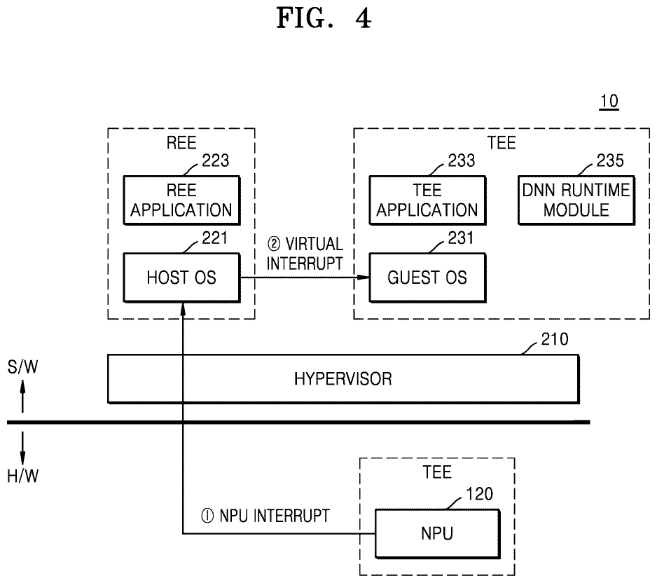

FIG. 2 is a diagram illustrating an example of an execution environment of an electronic device according to an implementation. FIG. 3 is a diagram for explaining an example of an operation of an execution environment of an electronic device according to a comparative example. FIG. 4 is a diagram for explaining an example of an operation of an execution environment of the electronic device according to an implementation.

Referring to FIG. 2, the electronic devices 10 may be implemented to perform operations (or functions) based on a plurality of execution environments that are isolated (or independent) from each other in a software or hardware manner.

Here, the plurality of execution environments may include a REE and a TEE as described with reference to FIG. 1, but are not limited thereto and may further include various types of execution environments that may be implemented to be isolated (or independent) from each other. In some implementations, the CPU 110 is expressed as a single CPU 110 in FIG. 2, but is not limited thereto, and may be implemented as a plurality of processors (e.g., a REE CPU, a TEE CPU, etc.) respectively corresponding to execution environments.

Referring to FIG. 2, for example, the CPU 110 may perform an operation in a REE during a first time period or in a TEE during another second time period. In this regard, hardware and authorities allocated to execution environments may be different from each other.

Referring to FIG. 2, the CPU 110, the MMU 131, and the memory 140 may be allocated (or driven) to one of the REE and the TEE. The NPU 120, the IOMMU 133, and the NPU enclave 141 may be allocated (or driven) to the TEE.

Referring to FIG. 2, specified areas of the memory 140 may be allocated to the execution environments. The CPU 110 may read and write data in an area of the memory 140 allocated to the REE in the REE. In some implementations, the CPU 110 and/or the NPU 120 may read and write data in an area (e.g., the NPU enclave 141) of the memory 140 allocated to the TEE in the TEE.

In some implementations, authorities and securities granted to the execution environments may be different. For example, the authority and security with respect to the TEE may be higher than the authority and security with respect to the REE. For example, the CPU 110 may access the area of the memory 140 allocated to the REE in the TEE to read and write data, but may not be accessible to hardware or information allocated to the TEE in the REE.

The artificial neural network data may be stored in an area (e.g., the NPU enclave 141) of the memory 140 of the TEE, and the CPU 110 may not be accessible to the artificial neural network data in the REE. Accordingly, the artificial neural network data may not be exposed to the outside.

Referring to FIG. 2, the CPU 110 may execute virtual operating systems (a host OS 221 and a guest OS 231) through the hypervisor 210 in each of different execution environments, such as the REE and the TEE. Applications such as a REE application 223, a TEE application 233, and a DNN runtime module 235 may be executed on the virtual operating systems.

For example, the CPU 110 may use the hypervisor 210 to execute the REE application 223 on the host OS 221 executed in the REE. In some implementations, the CPU 110 may use the hypervisor 210 to execute the TEE application 233 and/or the DNN runtime module 235 on the guest OS 231 executed in the TEE.

Referring to FIG. 2, the NPU enclave 141 may be implemented as a logically isolated area from a virtualization-based TEE by the hypervisor 210. The NPU enclave 141, which is a partial area of the memory 140 allocated to virtual machine (VM) generated by the hypervisor 210, may be configured in an accessible form only within the TEE. The hypervisor 210 may provide independent virtual execution environments by dividing and controlling resources, such as the CPU 110, the memory 140, and an I/O device (the MMU 131), and one of the virtual environments may be set and operated as the TEE. Accordingly, the partial area of the memory 140 of the TEE may be set as the NPU enclave 141, which is an inference execution area dedicated to the NPU.

The DNN runtime module 235, which is an execution module for performing an artificial neural network-based inference task, may be configured to load a pre-trained artificial neural network model included in artificial neural network data from the NPU enclave 141, execute the model based on the input data, and output a result. In some implementations, the DNN runtime module 235 may be implemented to operate within the TEE to safely process sensitive inference data.

In an implementation, the DNN runtime module 235 may be configured to execute various operators, and may distribute various operators to a plurality of operation resources to perform operations by utilizing at least one of a plurality of operation resources such as the CPU 110 and the NPU 120. Here, as described with reference to FIG. 1, various operators may include a first operator supported by the NPU 120 and a second operator not supported by the NPU 120.

Referring to FIG. 3, unlike the electronic device 10 according to implementations of present disclosure, an NPU 120′ may operate in the REE in an electronic device 10′ according to the comparative example. Accordingly, when the NPU 120′ needs to perform the second operator after performing the first operator, the NPU 120′ provides a host OS 221′ driven in the REE with an NPU interrupt indicating completion of performance of the first operator and/or processing of the second operator so that a DNN runtime module 235′ processes the second operator in the REE.

Referring to FIG. 4, unlike the electronic device 10′ according to the comparative example, the NPU 120 may operate in the TEE in the electronic device 10 according to implementations of present disclosure. When the NPU 120 needs to perform the second operator after performing the first operator, the NPU 120 may provide the host OS 221 driven in the REE with the NPU interrupt indicating completion of performance of the first operator and/or processing of the second operator. In this regard, because the NPU interrupt needs to be processed through the kernel driver of the host OS 221 of the REE, a TEE-to-REE transition from the TEE to the REE may occur. Subsequently, in order for the kernel driver of the host OS 221 of the REE to transmit the NPU interrupt to the guest OS 231 of the TEE in the form of a virtual interrupt, a REE-to-TEE transition from the REE to the TEE may occur.

In other words, referring to FIGS. 3 and 4, in order to perform an inference operation in the TEE, a path for transferring the virtual interrupt to the guest OS 231 is added, and an inference latency inevitably occurs due to the occurrence of a transition between the TEE and the REE.

For example, the electronic device 10 according to implementations of present disclosure may perform an inference operation safely compared to the electronic device 10′ according to the comparative example, but a certain amount of inference latency may be involved.

According to implementations of present disclosure, the DNN runtime module 235 may adjust the execution order of operators of the artificial neural network, thereby reducing the number of transfers of the NPU interrupt and reducing the number of TEE-to-REE transitions from the TEE to the REE. Accordingly, according to implementations of present disclosure, the inference latency may be effectively reduced while safely performing the inference operation in the TEE.

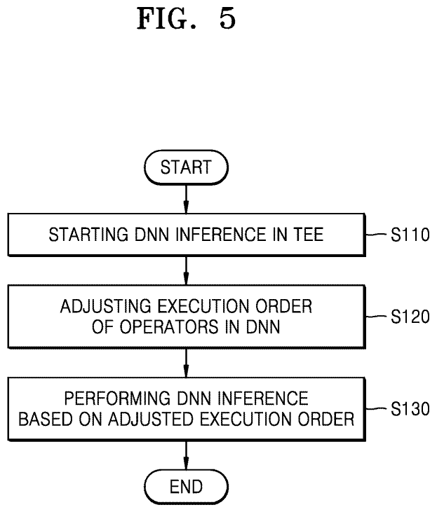

Hereinafter, performing artificial neural network-based inference in the TEE according to implementations of present disclosure will be described in detail with reference to FIGS. 5 to 11.

FIG. 5 is a flowchart illustrating a method of performing an artificial neural network-based inference according to an implementation. The artificial neural network-based inference according to the present implementation illustrated in FIG. 5 may be performed by, for example, the electronic device 10, the CPU 110 (or the DNN runtime module 235), and/or the NPU 120 of FIGS. 1 and 2.

In operation S110, the electronic device 10 may initiate the artificial neural network-based inference in a TEE. For example, in response to an inference request from the REE application 223 of FIG. 2, the guest OS 231 and/or the DNN runtime module 235 may initiate an inference operation in the TEE.

Here, the inference request may include input data (e.g., images, text, sensor values, etc.), seed data for diversity or reproducibility of results in some generative models or probabilistic inference, and/or additional condition information data (class labels and environmental parameters in conditional generation, classification, customized inference, etc.)

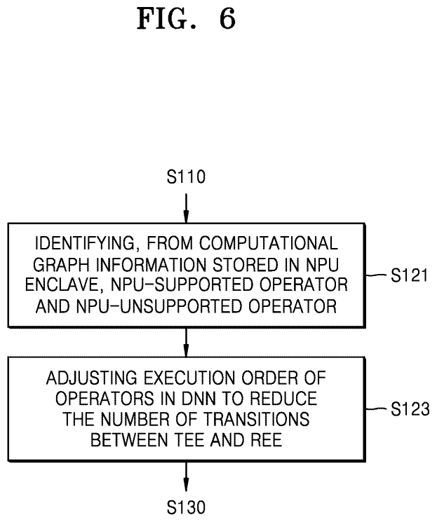

In operation S120, the electronic device 10 may adjust an execution order of operators of an artificial neural network. For example, the DNN runtime module 235 may adjust the execution order of operators to reduce the number of transitions between the TEE and the REE. This will be described in detail with reference to FIG. 6.

In operation S130, the electronic device 10 may perform the artificial neural network-based inference in the TEE based on the adjusted execution order. For example, according to the adjusted execution order, the NPU 120 may perform operators supported by the NPU 120 in the TEE, the CPU 110 may then perform operators not supported by the NPU 120 in the TEE, and the NPU 120 may then perform operators supported by another NPU 120 in the TEE.

In other words, the operators supported by the NPU 120 and the operators not supported by the NPU 120 may be performed alternately, and based on an execution order scheduled by the DNN runtime module 235, the operators supported by the NPU 120 may be performed by the NPU 120 in the TEE, and the operators not supported by the NPU 120 may be performed by the CPU 110 in the TEE.

FIG. 6 is a flowchart for explaining in more detail operation S120 of a method of performing an artificial neural network-based inference according to an implementation.

Referring to FIG. 6, operation S120 may include operations S121 and S123.

In operation S121, the electronic device 10 may identify operators according to whether the operators are supported by the NPU 120 from computational graph information of an artificial neural network stored in the NPU enclave 141 of FIGS. 1 and 2. For example, the CPU 110 may identify a first operator supported by the NPU 120 and a second operator not supported by the NPU 120 from the computational graph information of the artificial neural network stored in at least one NPU enclave 141.

More specifically, the DNN runtime module 235 may load identification information of each of the operators together with the computational graph information of the artificial neural network stored in the at least one NPU enclave 141 in the TEE, and may easily identify the first operator supported by the NPU 120 and the second operator not supported by the NPU 120 based on the identification information of each operator.

In the implementation, the identification information of each of the operators may be included in the computational graph information of the artificial neural network in a metadata format. For example, the identification information may be tag data in which an operator corresponding to the first operator supported by the NPU 120 is indicated as 0 or False, and an operator corresponding to the second operator not supported by the NPU 120 is indicated as 1 or True. In some implementations, for example, the identification information of each operator, i.e., whether each operator is supported by the corresponding hardware, may be predefined by a remote model provider (e.g., a server) at the time of model compilation or deployment. Accordingly, the CPU 110 (or the DNN runtime module 235) may easily identify the first operator supported by the NPU 120 and the second operator not supported by the NPU 120 based on the identification information of each operator.

In operation S123, the electronic device 10 may adjust an execution order of the operators of a computational graph to reduce the number of transitions between the TEE configured to perform the first operator supported by the NPU 120 and a REE configured to perform the second operator not supported by the NPU 120.

The DNN runtime module 235 may reconfigure the execution order so that as many operators as possible may be batch executed within the same processing device (the CPU 110 or the NPU 120).

For example, the DNN runtime module 235 may divide the computational graph into a plurality of subgraphs according to a greedy-based algorithm, and may adjust the execution order based on the plurality of subgraphs.

Here, the greedy-based algorithm may be a method of sequentially visiting a root node of the computational graph, including all nodes with the same NPU-supported operator among operator nodes without a computational dependence (i.e., with an indegree of 0) in the current subgraph, and removing nodes included in the current subgraph from the artificial neural network computational graph. In some implementations, the indegree may represent the number of all input edges connected to a single node.

Specifically, the DNN runtime module 235 may map the operators on the computational graph to the plurality of subgraphs based on whether the operators are supported by the NPU 120 and the indegree of the operator nodes on the target computational graph processed step by step.

The DNN runtime module 235 may adjust the execution order of the operators of the computational graph based on the plurality of subgraphs.

For example, the DNN runtime module 235 may group operators with the same support state into a single subgraph by referring to a flag (e.g., ExitFlag) indicating whether the operator nodes with the indegree of 0 on the target computational graph processed step by step are supported by the NPU 120. As a result of performing operation S 121, the flag ExitFlag of the first operators supported by the NPU 120 may be set to False, and the flag ExitFlag of the second operators not supported by the NPU 120 may be set to True in advance. The entire computational graph includes such subgraph units, and the DNN runtime module 235 may assign each subgraph to the same processing device (the CPU 110 or the NPU 120).

In other words, the greedy-based division algorithm may indicate, with respect to the operator node with the indegree of 0 on the target computational graph processed step by step, collecting as many operator nodes as possible having the same flag ExitFlag as the operators to which the operator node belongs and forming the operator nodes as a single subgraph.

The electronic device 10 (or the DNN runtime module 235) may adjust the execution order of the computational graph so that the NPU 120 may group and process computable operators into a single execution unit as much as possible and the CPU 110 may group and process computable operators into a single execution unit as much as possible.

According to implementations of present disclosure, through the adjustment of the execution order, the number of transfers of NPU interrupt may be reduced, and the number of TEE-to-REE transitions from the TEE to the REE may be reduced. Accordingly, according to implementations of present disclosure, an inference latency may be effectively reduced while safely performing an inference operation in the TEE.

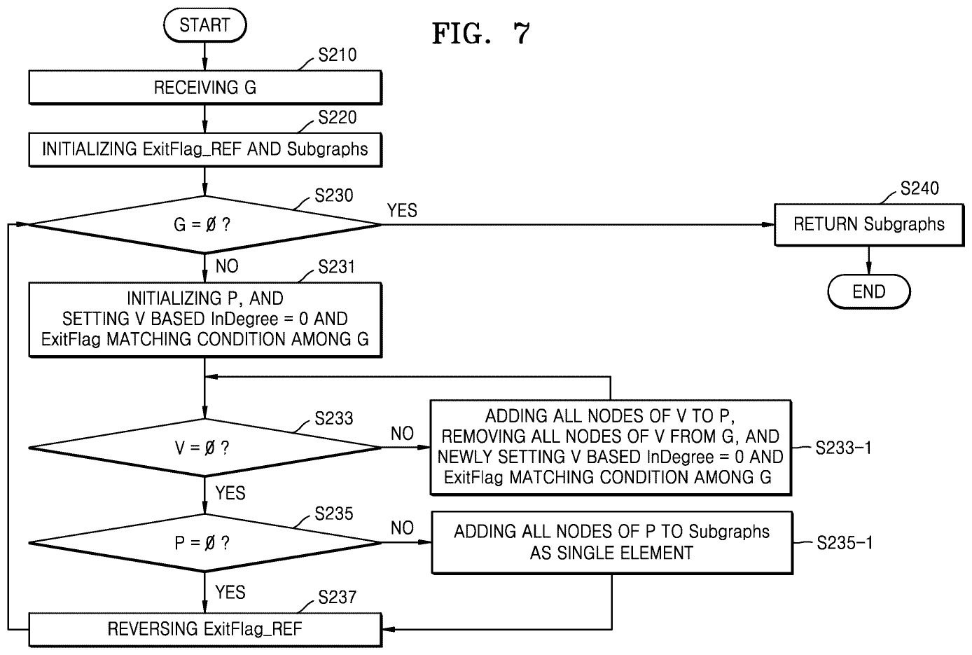

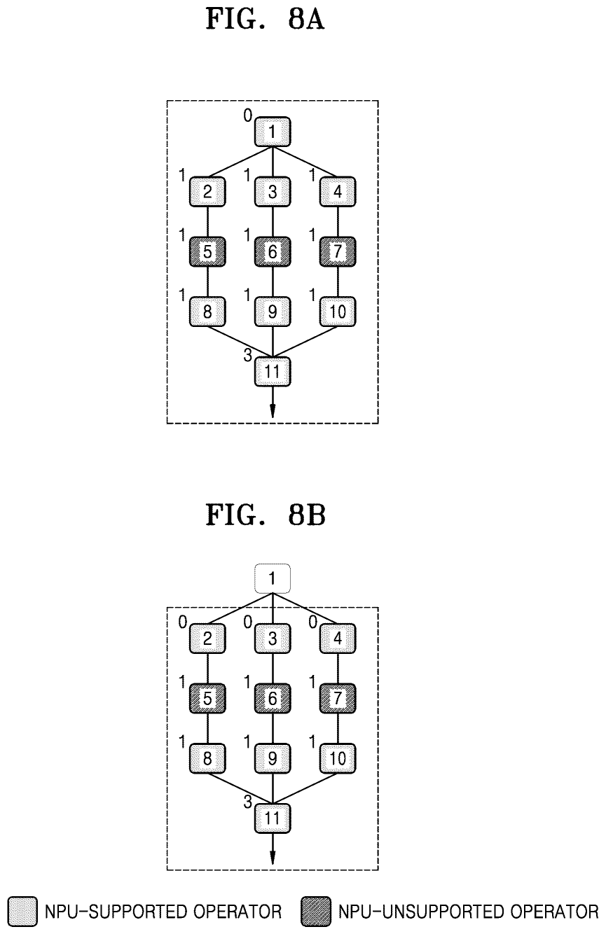

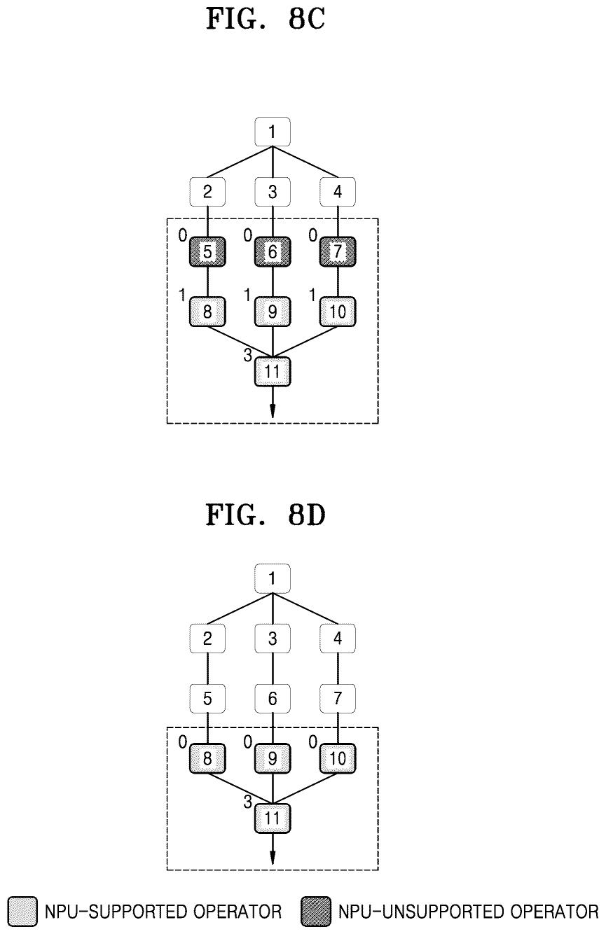

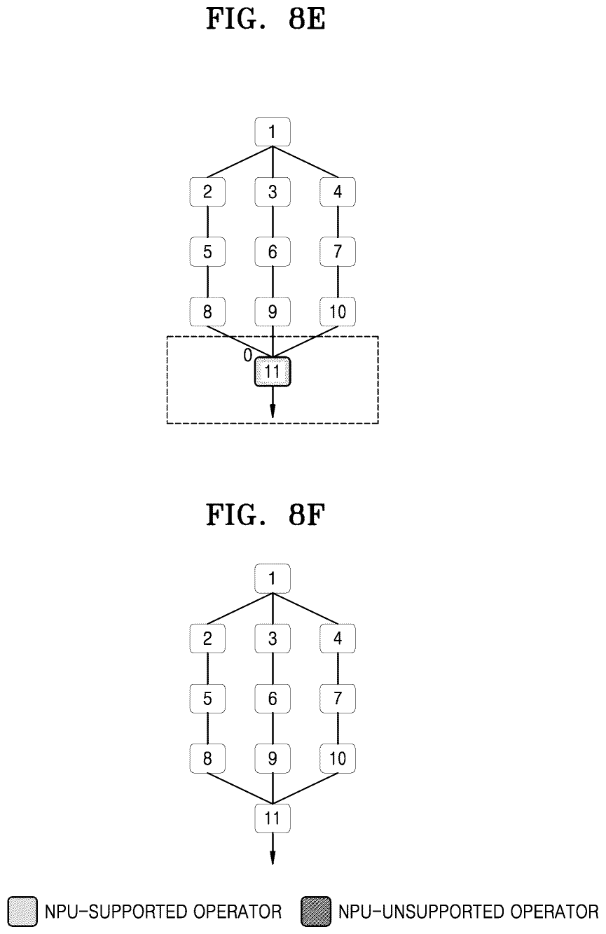

FIG. 7 is a flowchart of a greedy-based division algorithm that divides a computational graph into a plurality of subgraphs, according to an implementation. FIGS. 8A to 8F are examples for explaining a greedy-based division algorithm according to an implementation. The greedy-based division algorithm illustrated in FIG. 7 according to the present implementation may be performed by, for example, the electronic device 10 and/or the CPU 110 (or the DNN runtime module 235) of FIGS. 1 and 2.

In operation S210, the DNN runtime module 235 may receive information of a computational graph G. Here, the information of the computational graph G may be loaded from the NPU enclave 141.

In operation S220, the DNN runtime module 235 may initialize a reference flag ExitFlag_REF and a set Subgraphs. For example, the DNN runtime module 235 may set the reference flag ExitFlag_REF to False and set the set Subgraphs to an empty set. Here, the reference flag ExitFlag_REF may indicate a reference value for comparison with the flag ExitFlag of each operator of the computational graph G, and the set Subgraphs may indicate a set that stores a division result (divided subgraphs).

In operation S230, the DNN runtime module 235 may determine whether the current computational graph G is the empty set. Here, the current computational graph G may indicate a set including all operator node(s) of the computational graph G currently being processed.

Based on the determination that the current computational graph G is not the empty set, the DNN runtime module 235 may proceed to operation S231.

In operation S231, the DNN runtime module 235 may initialize a partition P, and set an operator node having the same flag as the reference flag ExitFlag_REF among operator nodes of the current computational graph G and having an indegree of 0 as a set V. Here, the partition P and the set V may indicate an intermediate set for deriving the set Subgraphs, which is a final division result.

In operation S233, the DNN runtime module 235 may determine whether the set V is an empty set. Based on the determination that the set V is not the empty set, the DNN runtime module 235 may proceed to operation S233-1.

In operation S233-1, the DNN runtime module 235 may add all operator nodes of the set V to the partition P, remove all operator nodes of the set V from the current computational graph G, and newly set an operator node having the same flag as the reference flag ExitFlag_REF among the operator nodes of the computational graph G from which all operator nodes of the set V are removed and having the indegree of 0 as the set V. After operation S233-1, the DNN runtime module 235 may proceed to operation S233 again.

For example, as operation S233-1 is repeatedly performed until the set V is the empty set, the DNN runtime module 235 may collect the operator node having the same flag as the reference flag ExitFlag_REF among the currently processed computational graph G and having the indegree of 0 in the partition P.

In operation S235, based on the determination that the set V is the empty set, the DNN runtime module 235 may determine whether the partition P is an empty set.

In operation S235-1, based on the determination that the partition P is not the empty set, the DNN runtime module 235 may add all operator nodes of the partition P to the current set Subgraphs as a single element. Here, all operator nodes of the partition P may be considered as a single subgraph, which may be added as the single element of the set Subgraphs.

For example, in operation S235-1, the DNN runtime module 235 may add the operator node(s) having the same flag as the reference flag ExitFlag_REF among the currently processed computational graph G and having the indegree of 0 to the set Subgraphs as a single subgraph.

Based on the determination that the partition P is the empty set in operation S235, or after performing operation S235-1, the DNN runtime module 235 may proceed to operation S237.

In operation S237, the DNN runtime module 235 may reverse the reference flag ExitFlag_REF. For example, when the reference flag ExitFlag_REF is False, the reference flag ExitFlag_REF may be reversed to True, and when the reference flag ExitFlag_REF is True, the reference flag ExitFlag_REF may be reversed to False.

After operation S237, the DNN runtime module 235 may proceed to operation S230 again. Based on the determination that the current computational graph G is the empty set in operation S230, the DNN runtime module 235 may proceed to operation S240.

For example, as operations S231 to S237 are repeatedly performed until the current computational graph G is the empty set, operators on the computational graph G may be mapped to subgraphs corresponding to elements of the set Subgraphs so that as many operators as possible are continuously executed in the same processing device (the CPU 110 or the NPU 120).

In operation S240, the DNN runtime module 235 may return the set Subgraphs, which is the final result.

Hereinafter, the examples illustrated in FIGS. 8A to 8F will be described based on the description given with reference to FIG. 7.

FIGS. 8A to 8F are diagrams illustrating that operator nodes included in the current computational graph G are empty sets as the greedy-based division algorithm according to the present implementation is applied.

Referring to FIGS. 8A to 8F, the entire computational graph G includes operator nodes 1 to 11. In FIG. 8A, the current computational graph G corresponds to the entire computational graph G indicated by a dashed line, in FIG. 8B, the current computational graph G corresponds to a portion indicated by a dotted line excluding the operator node 1 in the entire computational graph G, and in FIG. 8F, the current computational graph G corresponds to the empty set.

Referring to FIG. 8A, because only the operator node 1 has an indegree of 0 and the flag ExitFlag of False based on the reference flag ExitFlag_REF being False, the operator node 1 may be added to the partition P and be removed from the entire computational graph G (P={1}, Subgraphs={ }).

Referring to FIG. 8B, because each of the operator nodes 2, 3, and 4 has an indegree of 0 and the flag ExitFlag of False based on the reference flag ExitFlag_REF still being False and the operator node 1 being removed, the operator nodes 2, 3, and 4 may be added to the partition P and be removed from the current computational graph G (ExitFlag_REF=False, P={1, 2, 3, 4}, Subgraphs={ }).

Referring to FIG. 8C, because there is no operator node having an indegree of 0 and the flag ExitFlag of False based on the reference flag ExitFlag_REF still being False and the operator nodes 2, 3, and 4 being removed, the reference flag ExitFlag_REF may be set to True, and the partition P may be added as an element of the set Subgraphs and initialized (ExitFlag_REF=True, P={ }, Subgraphs={{1, 2, 3, 4}}). Subsequently, because each of the operator nodes 5, 6, and 7 has an indegree of 0 and the flag ExitFlag of True based on the reference flag ExitFlag_REF being True, the operator nodes 5, 6, and 7 may be added to the partition P and removed from the current computational graph G (ExitFlag_REF=True, P={5, 6, 7}, Subgraphs={{1, 2, 3, 4}}).

Referring to FIG. 8D, because there is no operator node having an indegree of 0 and the flag ExitFlag of True based on the reference flag ExitFlag_REF still being True and the operator nodes 5, 6, and 7 being removed, the reference flag ExitFlag_REF may be set to False, and the partition P may be added as an element of the set Subgraphs and initialized (ExitFlag_REF=False, P={ }, Subgraphs={{1, 2, 3, 4}, {5, 6, 7}}). Subsequently, because each of the operator nodes 8, 9, and 10 has an indegree of 0 and the flag ExitFlag of False based on the reference flag ExitFlag_REF being False, the operator nodes 8, 9, and 10 may be added to the partition P and removed from the current computational graph G (ExitFlag_REF=False, P={8, 9, 10}, Subgraphs={{1, 2, 3, 4}, {5, 6, 7}}).

Referring to FIG. 8E, because only the operator node 11 has an indegree of 0 and the flag ExitFlag of False based on the reference flag ExitFlag_REF still being False, and the operator nodes 8, 9, and 10 being removed, the operator node 11 may be added to the partition P and removed from the current computational graph G (ExitFlag_REF=False, P={8, 9, 10, 11}, Subgraphs={{1, 2, 3, 4}, {5, 6, 7}}).

Referring to FIG. 8F, because there is no operator node having an indegree of 0 and the flag ExitFlag of True based on the reference flag ExitFlag_REF still being False and the operator node 11 being removed, the reference flag ExitFlag_REF may be set to True, and the partition P may be added as an element of the set Subgraphs (ExitFlag_REF=True, Subgraphs={{1, 2, 3, 4}, {5, 6, 7}}, {8, 9, 10, 11}). Here, because there is no longer operator node in the current computational graph G (i.e., the current computational graph G is the empty set), the set Subgraphs may be returned Subgraphs={{1, 2, 3, 4}, {5, 6, 7}}, {8, 9, 10, 11}).

For example, based on an execution order corresponding to the set Subgraphs, the DNN runtime module 235 may be configured to group the operator nodes 1, 2, 3, and 4 to cause the NPU 120 to perform an operation, then group the operator nodes 5, 6, and 7 to cause the CPU 110 to perform the operation, and then group the operator nodes 8, 9, 10, and 11 to cause the NPU 120 to perform the operation.

In the implementation, the greedy-based division algorithm according to the present implementation may be implemented by the following pseudo-code, but is not limited thereto.

| 1: | function PARTITION(G) | | |
|---|---|---|---|
| 2: | [symbol] G: An input DNN computation graph | | |
| 3: | ExitFlag ← False | | |
| 4: | Subgraphs ← ø | | |
| 5: | while G ≠ ø do | [symbol] | Construct a partition in each iteration |
| 6: | P ← ø | [symbol] | Stores DNN operators in the current partition |
| 7: | V ← GETNODES(G, InDegree=0, ExitFlag=ExitFlag) | | |
| 8: | while V ≠ ø do | | |
| 9: | P ← P ∪ V | [symbol] | Add V to the current partition |

| | | | |
|---|---|---|---|
| 10: | G ← G − V | [symbol] | Remove from the graph |

| | |
|---|---|
| 11: | V ← GETNODES(G, InDegree=0, ExitFlag=ExitFlag) |
| 12: | end while |
| 13: | if P ≠ ø then |
| 14: | Subgraphs ← Subgraphs ∪ (P) |
| 15: | end if |
| 16: | ExitFlag ← ┐ExitFlag |
| 17: | end while |
| 18: | return Subgraphs |
| 19: | end function |

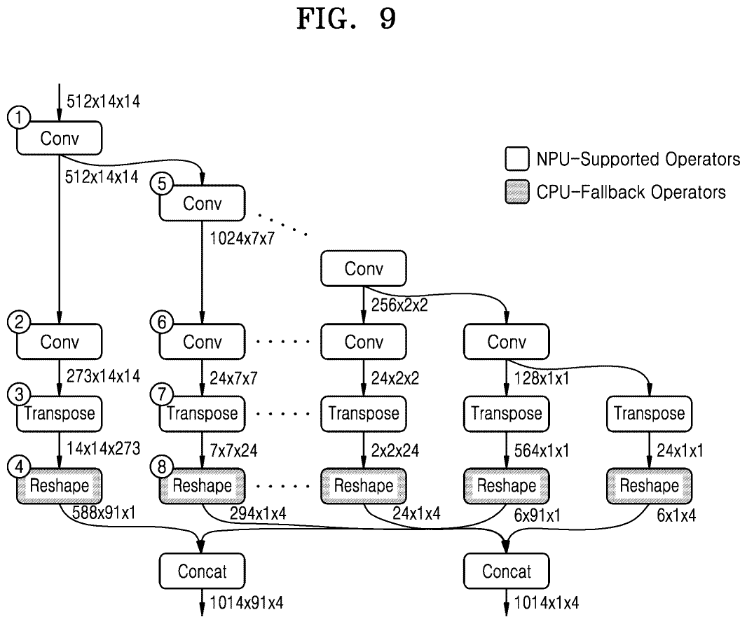

FIGS. 9, 10, and 11 are diagrams for explaining that the number of transitions from a TEE to a REE (TEE-to-REE transition) is reduced, according to implementations.

Referring to a computational graph of an artificial neural network shown in FIG. 9, when the DNN runtime module 235 does not adjust an execution order of operators based on a greedy-based algorithm according to implementations of present disclosure, the operators are configured to be executed according to a depth-first search (DFS) algorithm, which is a basic execution order.

When the operators are executed according to the DFS algorithm, that is, as the operators are executed in a numerical order from the operator 8 to the operator 1, two exits occur.

On the other hand, when the DNN runtime module 235 adjusts the execution order of operators based on the greedy-based algorithm according to implementations of present disclosure, that is, the operators 1, 2, 3, 5, 6, and 7 are grouped into a single subgraph and batch executed, and the operators 4 and 8 are grouped into another subgraph and batch executed, and thus one exit may occur.

Here, the exit may not simply end a function or end a process, but may represent a system level event in which a transition(s) occurs between the TEE and the REE due to a process request of an NPU for a CPU fallback operator. For example, the exit may refer to a transition between the TEE and the REE at least two to three times to process a single NPU interrupt, as described with reference to FIG. 1.

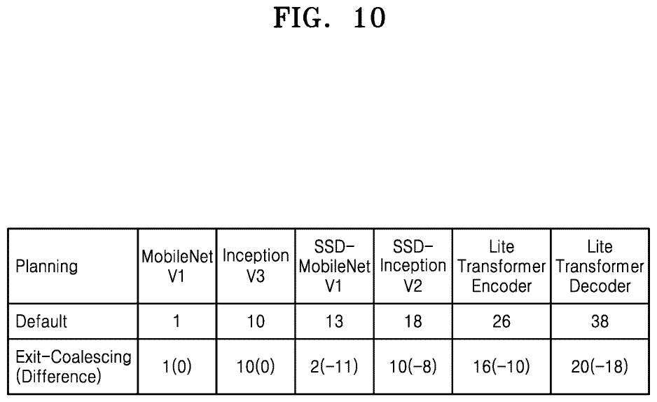

Referring to FIG. 10, with respect to six DNN models (MobileNet V1, Inception V3, SSD-MobileNet V1, SSD-Inception V2, Lite Transformer Encoder, and Lite Transformer Decoder), exit default when the operators are executed according to the DFS algorithm and exit-coalescing when the operators are executed based on the greedy-based algorithm according to implementations of present disclosure are illustrated.

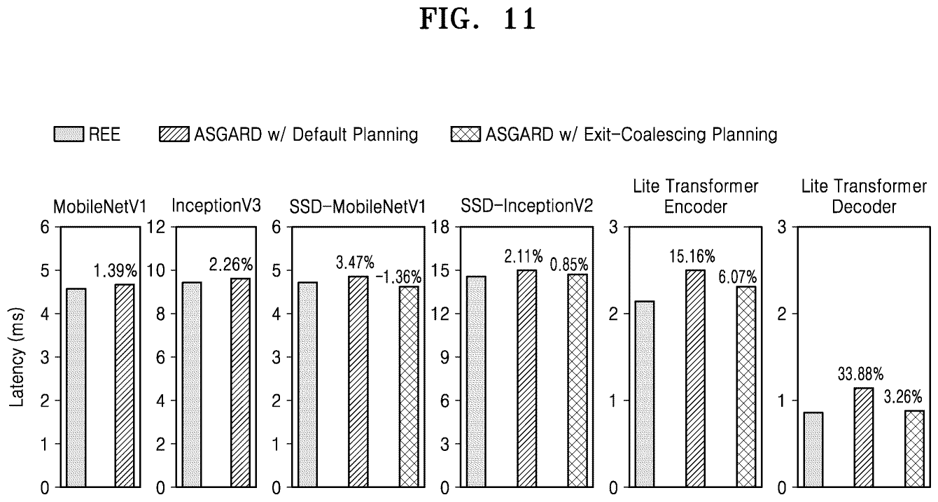

Referring to FIG. 11, with respect to the six DNN models (MobileNet V1, Inception V3, SSD-MobileNet V1, SSD-Inception V2, Lite Transformer Encoder, and Lite Transformer Decoder), an inference latency in the REEE, an inference latency in the TEE according to the DFS algorithm (ASGARD w/Default Planning), and an inference latency in the TEE according to the greedy-based algorithm according to implementations of present disclosure (ASGARD w/Exit-Coalescing Planning) are illustrated.

Referring to FIGS. 10 and 11, when comparing the Greedy-based algorithm and the Depth-First Search (DFS) algorithm according to implementations of present disclosure, the number of exits in the Single Shot Detector (SSD) model may decrease from 13 to 18 to 2 to 10, and in the Lite Transformer from 26 to 38 to 16 to 20. In some implementations, upon comparing inference in the REE with inference in the TEE according to the greedy-based algorithm according to implementations of present disclosure, the SSD may significantly reduce the inference latency from 3.47% to 2.11% to −1.36% to 0.85% and the Lite Transformer from 15.16% to 33.88% to 6.07% to 3.26%.

Referring to FIGS. 10 and 11, when the operators are executed based on the greedy-based algorithm according to implementations of present disclosure, exits may be removed up to 18 times (the Lite Transformer Decoder) compared to when the operators are executed according to the DFS algorithm, thereby effectively reducing the inference latency in the TEE.

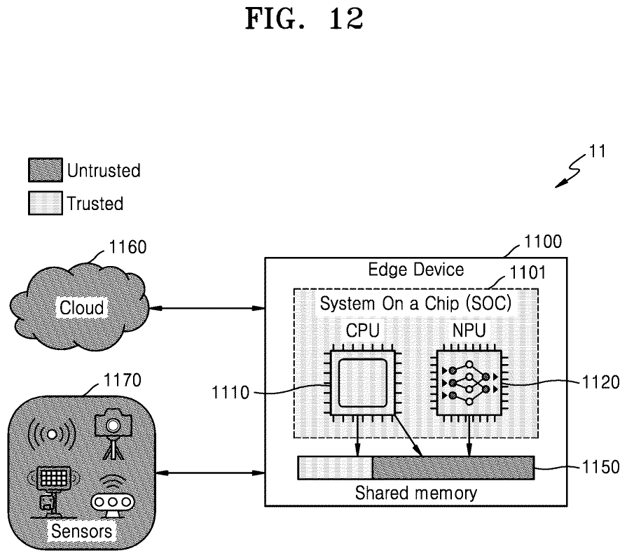

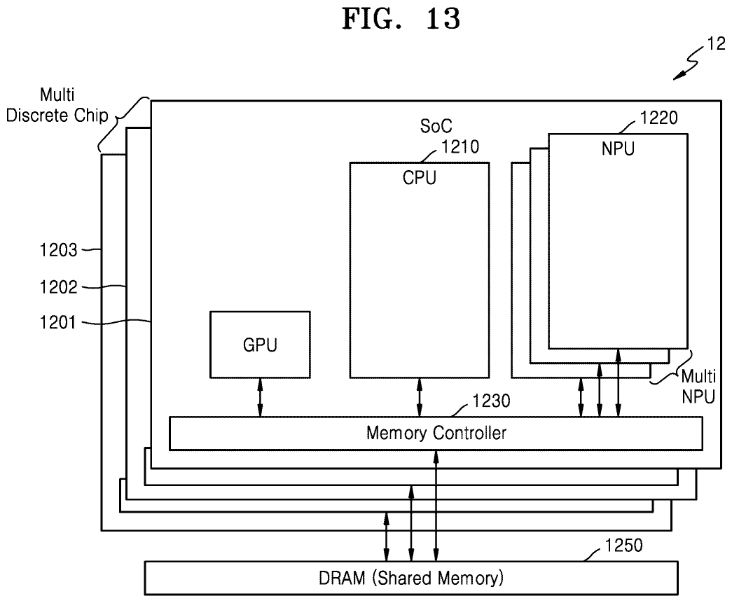

FIG. 12 is a diagram illustrating an example of a system according to an implementation.

Referring to FIG. 12, a system 11 may include an edge device 1100, a cloud 1160, and/or sensors 1170.

The edge device 1100 may include an SoC 1101 and shared memory 1150, the SoC 1101 may correspond to the SoC 100 of FIG. 1, and the shared memory 1150 may correspond to the memory 140 of FIG. 1.

The SoC 1101 may include a CPU 1110 and an NPU 1120, and the CPU 1110 and the NPU 1120 may share and use the shared memory 1150.

The edge device 1100 may receive and process data from the sensors 1170. In a process of processing the data, the edge device 1100 may perform an artificial neural network-based inference using the NPU 1120. In some implementations, the edge device 1100 may store the processed data in the cloud 1160. When the edge device 1100 receives and processes the data from the sensors 1170 and transmits the processed data to the cloud 1160, the transmitted and received data may be safely protected.

Through the edge device 1100 using the implementations described above with reference to FIGS. 1 to 11, an inference latency may be effectively reduced while safely performing an inference operation in a TEE of the system 11.

FIG. 13 is a diagram illustrating an example of an electronic device according to an implementation.

Although a case where one SoC operates has been described with reference to FIGS. 1 to 12, referring to FIG. 3, in some implementations, a plurality of individual SoCs 1201 to 1203 may be included in an electronic device 12. The plurality of individual SoCs 1201 to 1203 may share memory 1230. In FIG. 13, the shared memory 1230 is indicated as DRAM in an implementation, but implementations of present disclosure is not limited thereto. The plurality of individual SoCs 1201 to 1203 may have structures corresponding to each other, and have partially different structures. Representatively, the SoC 1201 may include a CPU 1210 and at least one NPU 1220. In some implementations, the SoC 1201 may further include a GPU as needed. In some implementations, a plurality of NPUs 1220 may be present in one chip as needed. The electronic device 12 may operate by using the implementations described with reference to FIGS. 1 to 12, thereby effectively reducing an inference latency while safely performing an inference operation in a TEE.

In some implementations, the CPU/central processor (e.g., CPU 110, 1110, 1210) discussed in the present disclosure may include one or more processors. In some implementations, all of the functions of the CPU may be performed by a single processor. In other implementations, the functions of the CPU may be distributed among multiple processors (e.g., one processor performs a subset of the functions of the CPU while one or more other processors perform the remaining functions of the CPU.)

In some implementations, the NPU/neural processor (e.g., NPU 120, 1120, 1220) discussed in the present disclosure may include one or more processors. In some implementations, all of the functions of the NPU may be performed by a single processor. In other implementations, the functions of the NPU may be distributed among multiple processors (e.g., one processor performs a subset of the functions of the NPU while one or more other processors perform the remaining functions of the NPU.)

While the present disclosure contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While implementations of present disclosure has been particularly shown and described with reference to implementations thereof, it will be understood that various changes in form and details may be made therein without departing from the spirit and scope of the following claims.

What is claimed is:

1. An electronic device comprising:
one or more central processors;
one or more neural processors; and
memory comprising at least one neural processor enclave having a trusted execution environment (TEE) isolated from a rich execution environment (REE) in which system software of the one or more central processors is executed,
wherein the one or more central processors are configured to:
based on computational graph information of an artificial neural network stored in the at least one neural processor enclave, identify a first operator supported by the one or more neural processors and a second operator not supported by the one or more neural processors, and
adjust an execution order of operators of a computational graph to reduce a number of transitions between the TEE configured to perform the first operator and the REE configured to perform the second operator.

2. The electronic device of claim 1, wherein the second operator is executed by the one or more central processors.

3. The electronic device of claim 1, wherein the one or more central processors are configured to reconfigure the execution order of the operators of the computational graph so that as many operators as possible are batch executed within a same processing device.

4. The electronic device of claim 1, wherein
the one or more central processors are configured to:
based on a support status of an operator by the one or more neural processors and an indegree of an operator node on a target computational graph processed step by step, map the operators of the computational graph to a plurality of subgraphs, and
adjust the execution order of the operators of the computational graph based on the plurality of subgraphs.

5. The electronic device of claim 1, wherein
the one or more central processors are configured to:
divide the computational graph into a plurality of subgraphs based on a greedy-based algorithm, and
adjust the execution order of the operators of the computational graph based on the plurality of subgraphs.

6. The electronic device of claim 5, wherein the greedy-based algorithm includes:
receiving computational graph information;
initializing a reference flag and a first set;
determining an emptiness status of a current computational graph; and
based on determining that the current computational graph is an empty set, returning the first set that is a final result.

7. The electronic device of claim 6, wherein the greedy-based algorithm includes:
based on determining that the current computational graph is not the empty set,
initializing a second set and setting an operator node having a same flag as the reference flag and an indegree of 0 among operator nodes of the current computational graph to a third set;
determining an emptiness status of the third set;
based on determining that the third set is not the empty set, removing all operator nodes of the third set from the current computational graph, and newly setting an operator node having the same flag as the reference flag and the indegree of 0 among the operator nodes of the computational graph from which all of the operator nodes of the third set are removed; and
determining again the emptiness status of the third set.

8. The electronic device of claim 7, wherein the greedy-based algorithm includes:
based on determining that the third set is the empty set, determining an emptiness status of the second set;
based on determining that the second set is not the empty set, adding all operator nodes of the second set to the first set as a single element, and reversing the reference flag; and
determining again the emptiness status of the current computational graph.

9. The electronic device of claim 7, wherein the greedy-based algorithm includes:
based on determining that the third set is the empty set, determining an emptiness status of the second set;
based on determining that the second set is the empty set, reversing the reference flag; and
determining again the emptiness status of the current computational graph.

10. The electronic device of claim 7, wherein
the second set and the third set are intermediate sets for deriving the first set that is a final result.

11. A method of performing an artificial neural network-based inference of one or more central processors included in an electronic device, wherein the electronic device further comprises one or more neural processors and memory comprising at least one neural processor enclave having a trusted execution environment (TEE) isolated from a rich execution environment (REE) in which system software of the one or more central processors is executed,
the method comprising:
based on computational graph information of an artificial neural network stored in the at least one neural processor enclave, identify a first operator supported by the one or more neural processors and a second operator not supported by the one or more neural processors; and
adjusting an execution order of operators of a computational graph to reduce a number of transitions between the TEE configured to perform the first operator and the REE configured to perform the second operator.

12. The method of claim 11, wherein the second operator is executed by the one or more central processors.

13. The method of claim 11, wherein adjusting the execution order of the operators of the computational graph includes reconfiguring the execution order of the operators of the computational graph so that as many operators as possible are batch executed within a same processing device.

14. The method of claim 11, wherein adjusting the execution order of the operators of the computational graph includes:
based on a support status of an operator by the one or more neural processors and an indegree of an operator node on a target computational graph processed step by step, mapping the operators of the computational graph into a plurality of subgraphs, and
adjusting the execution order of the operators of the computational graph based on the plurality of subgraphs.

15. The method of claim 11, wherein adjusting the execution order of the operators of the computational graph includes:
dividing the computational graph into a plurality of subgraphs based on a greedy-based algorithm, and
adjusting the execution order of the operators of the computational graph based on the plurality of subgraphs.

16. The method of claim 15, wherein the greedy-based algorithm includes:
receiving computational graph information;
initializing a reference flag and a first set;
determining an emptiness status of a current computational graph; and
based on determining that the current computational graph is an empty set, returning the first set that is a final result.

17. The method of claim 16, wherein the greedy-based algorithm includes:
based on determining that the current computational graph is not the empty set, initializing a second set and setting an operator node having a same flag as the reference flag and an indegree of 0 among operator nodes of the current computational graph to a third set;
determining an emptiness status of the third set;
based on the determining that the third set is not the empty set, removing all operator nodes of the third set from the current computational graph, and newly setting an operator node having the same flag as the reference flag and the indegree of 0 among the operator nodes of the computational graph from which all of the operator nodes of the third set are removed; and
determining again the emptiness status of the third set.

18. The method of claim 17, wherein the greedy-based algorithm includes:
based on determining that the third set is the empty set, determining an emptiness status of the second set;
based on determining that the second set is not the empty set, adding all operator nodes of the second set to the first set as a single element, and reversing the reference flag; and
determining again the emptiness status of the current computational graph.

19. The method of claim 17, wherein the greedy-based algorithm includes:
based on determining that the third set is the empty set, determining an emptiness status of the second set;
based on determining that the second set is the empty set, reversing the reference flag; and
determining again the emptiness status of the current computational graph.

20. An electronic device comprising:
a system on chip (SoC) comprising one or more central processors and one or more neural processors; and
memory comprising at least one neural processor enclave having a trusted execution environment (TEE) isolated from a rich execution environment (REE) in which system software of the central processors is executed,
wherein the central processors are configured to:
based on computational graph information of an artificial neural network stored in the at least one neural processor enclave, identify a first operator supported by the one or more neural processors and a second operator not supported by the one or more neural processors, and
adjust an execution order of operators of a computational graph to reduce a number of transitions between the TEE configured to perform the first operator and the REE configured to perform the second operator.
